(19) United States
(12) Patent Application Publication
(10) Pub. No.: US 2009/0010652 A1
(43) Pub. Date: Jan. 8, 2009

(54) OPTICAL MODULE AND OPTICAL TRANSCEIVER

(76) Inventor: Takami Iwafuji, Tokyo (JP)

Correspondence Address: NEC CORPORATION OF AMERICA, 6535 N. STATE HWY 161, IRVING, TX, 75039, US

(21) Appl. No.: 11/946,134

(22) Filed: Nov. 28, 2007

(30) Foreign Application Priority Data
Dec. 4, 2006 (JP) 2006-327520
Nov. 13, 2007 (JP) 2007-294937

(51) Int. Cl. H04B 10/00

(52) U.S. Cl. 398/135

(57) ABSTRACT

The present invention provides an optical communication module and the like in which a plurality of lead terminals necessary for the optical communication module is collected in one direction to effectively process the increased internal wiring. A plurality of lead terminals are arranged in a projecting manner over two stages of upper and lower stages at one end of a package 1, and a driver IC is arranged on a ceramic substrate. A step difference is formed at the edge of the ceramic substrate facing the optical element, and the optical element and the ceramic substrate are electrically connected using the step difference.

### CROSS-REFERENCE TO RELATED APPLICATION

This application is based upon and claims the benefit of priority from Japanese patent application No. 2006-327520, filed on Dec. 4, 2006, and Japanese patent application No. 2007-294937, filed on Nov. 13, 2007, the disclosure of which is incorporated herein in its entirety by reference.

### BACKGROUND OF THE INVENTION

1. Field of the Invention

The present invention relates to optical modules and optical transceivers, in particular, to an optical module and an optical transceiver for optical communication enabling miniaturization.

2. Description of the Related Art

Recently, expansion of transmission capacity is strongly desired in the optical communication system. Thus, higher performance, and accordingly, miniaturization and lower cost are desired in the optical module for optical communication. In this case, higher performance achieved by incorporating a driver IC in the optical module is one of the important factors in recent days. An example shown in FIG. 8 is known for achieving higher performance by incorporating the driver IC in the optical module.

FIG. 8 is a plan view showing an optical communication transmission module. In FIG. 8, a plurality of lead terminals 101A, 101A, . . . are arranged in a projecting manner at substantially equidistance at three sides (left end, upper end, and lower end in FIG. 8) of the periphery of a square package 101. A wiring ceramic substrate 103 is arranged on the inner side of the square package 101, and a driver IC 105 is mounted at the left end of the ceramic substrate 103.

An optical element 108, and a lens (optical system unit) 109 for outwardly outputting a laser light B output from the optical element 108 are mounted at the right end of the ceramic substrate 103. A thermistor 112, a monitor PD 113, a chip capacitor 114, a wiring board 107, and a terminating resistor are arranged around the optical element 108. A Peltier element 110 that manages temperature is arranged on the outer side (between the lens 109 and the package 101) of the optical element 108 and the lens 109. Furthermore, a carrier (not shown) is arranged on the lower side of the optical element 108 and the lens 109, and a base member is mounted on the lower side of the carrier. Reference numeral 101B indicates a light transmission guide unit for guiding the external output of the laser light B.

Similar to the case shown in FIG. 7, that in which the driver IC 105 is incorporated in the optical module to achieve higher performance is known (Japanese Laid-Open Patent No. 10-247741 (patent document 1), Japanese Laid-Open Patent No. 2005-17796 (patent document 2)).

However, in FIG. 8 and in the example of patent document 1, the size of the optical module is large to be built into a small transceiver (SFP etc.) which is the mainstream in current days, since the leads of the optical module are projecting out from three directions.

In the example disclosed in patent document 2, the leads of the optical module are projected out from one direction and thus can be easily built into a small transceiver (SFP etc.) which is the mainstream in current days, but heat radiation efficiency is not satisfactory since the Peltier element is not arranged, and shift in optical axis due to the temperature change cannot be prevented.

### SUMMARY OF THE INVENTION

It is an exemplary object of the invention to provide an optical communication transmission module and an optical transceiver with a configuration in which a driver IC is incorporated in the package and a plurality of lead terminals necessary for the optical communication module is collected to at least two stages in one direction, and being able to effectively process the increased internal wirings in the package.

In order to achieve the exemplary object of the invention, an optical communication transmission module according to an exemplary aspect of the invention relates to an optical communication transmission module in which a plurality of lead terminals is arranged in a projecting manner over two stages of upper and lower stages at one end of a package; a base member and a ceramic substrate are stacked from the lower side towards the upper side in an inner half region of the package; a driver IC is mounted on the ceramic substrate; the thickness of the base member is thinned and the Peltier elements and the carrier are stacked from the lower side towards the upper side, and the optical element and the optical system unit are sequentially arranged in a direction opposite to the leads on the carrier at another end on the inner side of the package; and the semiconductor laser light output from the optical element is output outwardly through the optical system unit; wherein a step difference is formed at the step part of the central part of the ceramic substrate in the inner half region on the lead side of the package, and wirings for the driver IC and the semiconductor laser power supply terminals are arranged collectively on the step difference.

Thus, the increased internal wirings in the package can be effectively processed since the step difference is formed at the step part of the central part of the ceramic substrate in the optical communication transmission module.

As an exemplary advantage according to the invention, an excellent optical module in which the terminals necessary for the optical communication module are arranged over two stages in only one direction and the internal wirings increased thereby are wired concentrating on the step difference region formed at the substrate portion of the central part, and a miniaturized optical transceiver configured including the same are obtained.

### BRIEF DESCRIPTION OF THE DRAWINGS

FIG. 1 is a longitudinal cross sectional view showing a configuration example according to a first exemplary embodiment of the present invention;

FIG. 2 is a plan view of the first exemplary embodiment;

FIG. 3 is a perspective view of the first exemplary embodiment;

FIG. 4 is a plan view showing a second exemplary embodiment according to the present invention;

FIG. 5 is a plan view showing a third exemplary embodiment according to the present invention;

FIG. 6 is a plan view showing a fourth exemplary embodiment according to the present invention;

FIG. 7 is a plan view showing a fifth exemplary embodiment according to the present invention; and

FIG. 8 is a plan view showing related art.

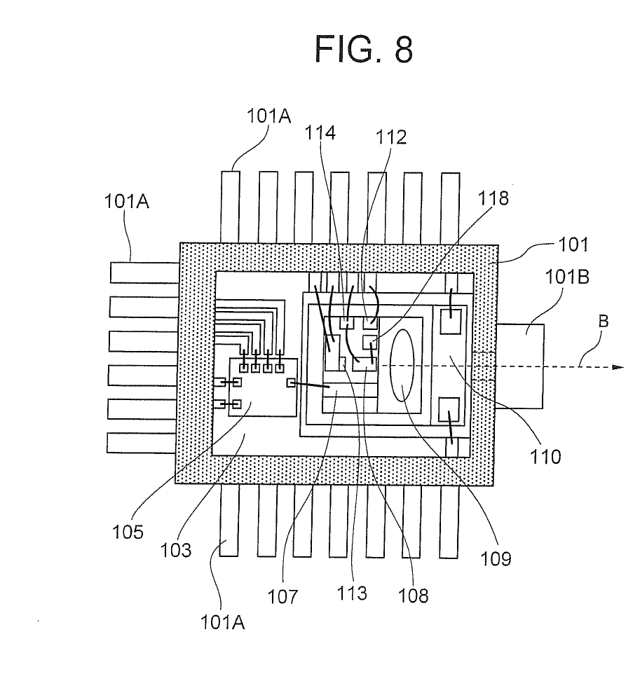

### EXEMPLARY EMBODIMENTS

### First Exemplary Embodiment

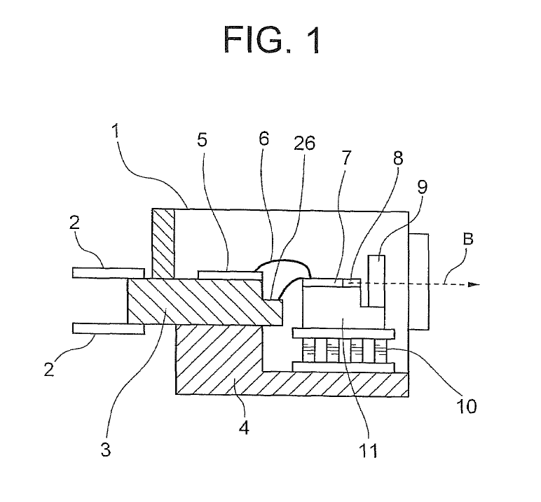

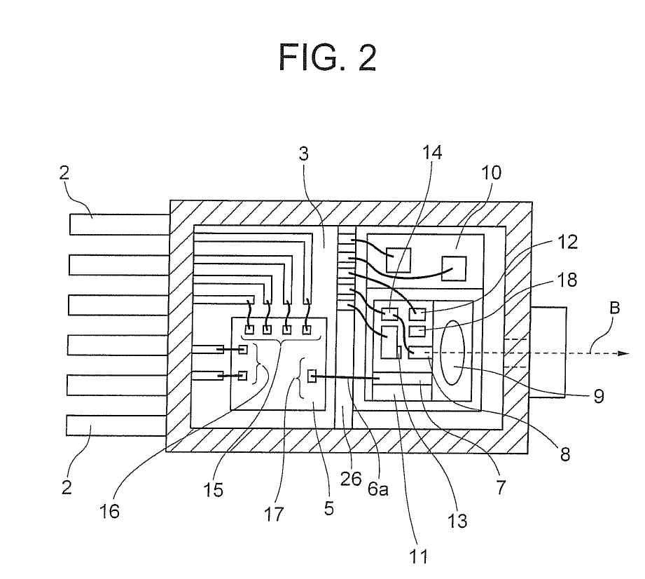

The first exemplary embodiment of the invention will now be described based on FIGS. 1 to 3.

In the first exemplary embodiment, the leads can be arranged towards the back side in one direction by forming a step difference 26 at the ceramic substrate of the package. The mounting onto a small transceiver (SFP: Small Form Pluggable modules) etc. is thereby facilitated.

In this case, IC wirings, power supply terminals of the semiconductor laser, and the like are easily and conveniently wired collectively towards the back side by forming the step difference at the ceramic substrate in the package. With this, the leads are collected in one direction towards the back side, and the lateral width direction of the module can be greatly reduced.

First, FIG. 1 is a cross sectional view showing an optical communication transmission module. In FIG. 1, a plurality of leads 2 is arranged in a projecting manner in two stages of upper and lower stages at one end of the square package 1. A base member 4 and the ceramic substrate 3 are stacked from the lower side towards the upper side in an inner half region on the lead 2 side of the package 1, and a driver IC 5 is mounted on the ceramic substrate 3.

In the other inner half region opposite to the lead 2 of the package 1, the thickness of the base member 4 is thinned and Peltier elements 10 and a carrier 11 are stacked from the lower side towards the upper side, and furthermore, an optical element 8 and an optical system unit (lens) 9 are sequentially arranged on the carrier 11 in a direction opposite to the leads. The semiconductor laser light output from the optical element 8 is output outwardly through the optical system unit 9.

Features lie in that a step difference 26 is formed at the step part of the central part of the ceramic substrate 3 in the inner half region on the lead 2 side of the package 1, and the wirings 7 for the driver IC and the semiconductor laser power supply terminals are collectively arranged on the step difference.

This will be further described in detail below. A plurality of leads 2 is arranged in a projecting manner over two stages of upper and lower stages at one end (left end of FIG. 1) of the square package 1. The Peltier elements 10 and the carrier 11 are mounted from the lower side towards the upper side on the inner side of the optical module. The wiring board 7, the optical element 8 including a laser element and an electro-absorption modulator, the optical system unit (lens) 9, a monitor photodiode 13, and a temperature sensor thermistor 12 are mounted on the upper surface of the carrier 11.

The package 1 includes the ceramic substrate 3 and the leads 2 joined thereto for wiring. The base member 4 is preferably made of material having satisfactory heat conduction property (CuW or the like). Furthermore, the driver IC 5 is mounted on the inner side of the package 1 as described above.

The step difference 26 for optical communication transmission module is formed at the central part of the ceramic substrate 3, and the leads 2 are arranged only on one side.

In this case, the optical module does not need to be expanded in the lateral width direction since the leads 2 are arranged in two stages. Further, the entering of noise to the signal line can be suppressed with a configuration in which the upper stage of the leads 2 is for signal line and the lower stage of the leads 2 is for DC current line. All FIGS. 1 to 3 are the same configurations. In the exemplary embodiment shown in FIGS. 1 to 3, the step difference 26 is formed at the middle of the left end of the square package 1, and thus expansion of the optical module in the lateral width direction becomes unnecessary. The entering of noise to the signal line may also be suppressed with a configuration in which the upper stage of the leads 2 is for DC current line and the lower stage of the leads 2 is for signal line.

Although heat generated by the driver IC 5 is conducted to the wiring board through a wiring 6, heat will not flow to the optical element 8 since heat will be radiated by the carrier 11. Stable operation is thus realized without influencing the properties of the optical element 8 by heat from the driver IC 5. Note that the number of electrode pads of the driver IC 5 is not limited to the illustrated pads.

The operation of the exemplary embodiment will now be described.

First, attenuated and degraded high frequency electrical wave signal is input to an input electrode pad 16 of the driver IC 5 through the leads 2 and the wirings on the ceramic substrate 3. The attenuated and degraded signal is shaped and amplified and then input to the wiring board 7 from the output electrode pad 17 via the connection wire 6a by the driver IC 5. The wiring board 7 is preferably made of material having satisfactory high frequency transmission property such as ceramic. The pattern on the wiring board is such in which impedance resistance is matched.

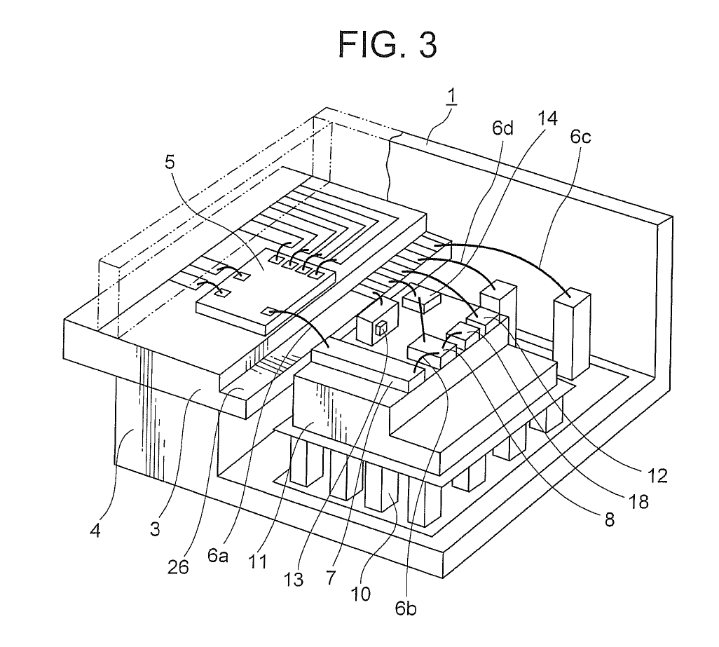

The step difference 26 for optical communication transmission module is formed at the central part of the ceramic substrate 3. Thus, the step difference 26 is partially set in a horizontal direction at the step difference 26, and the connection wires 6a, 6c, 6d are wired at the portion of the step difference of the ceramic substrate 3, as shown in FIG. 3.

In this case, the signal is transmitted to the optical element modulator of the optical element 8 via the connection wire 6b and the wiring board 7, and terminated by a terminating resistor 18. Power supply to the laser member of the optical element 8 is carried out from the leads on the lower stage and through the ceramic substrate 3 of multi-layer configuration. The light output from the optical element 8 is coupled to the lens 9. The optical element 8 is maintained at a constant temperature through Peltier control so that the resistance value of the temperature detection thermistor 12 is constant. The monitor photodiode 13 arranged on the back side of the optical element 8 detects the light output of the optical element 8.

According to the first exemplary embodiment, the step difference is formed on at least the ceramic substrate and the connection wires are wired at the step difference, whereby a spacious configuration can be achieved, and the optical communication transmission module of driver IC built-in type in which the lead terminals are arranged on one side can be obtained. Furthermore, the lateral width of the optical module is reduced by arranging the lead terminals towards the back side in one direction, and the optical module capable of being mounted on a small transceiver (SFP etc.) is obtained.

### Second Exemplary Embodiment

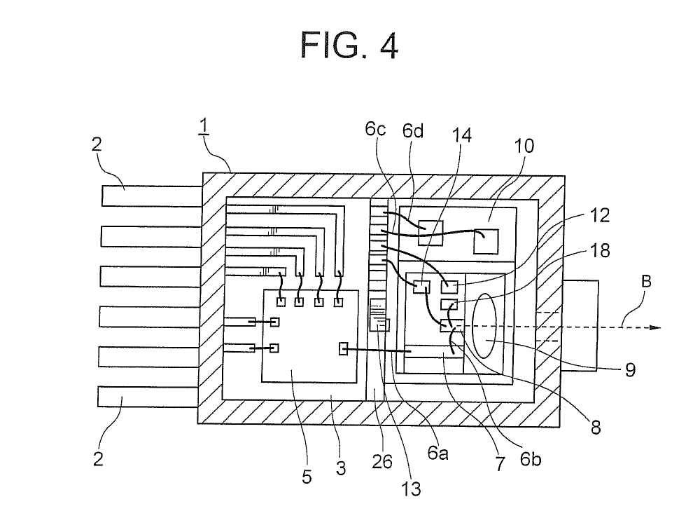

A second exemplary embodiment will now be described based on FIG. 4. Same reference numerals are used for the components same as in the first exemplary embodiment described above.

The second exemplary embodiment shown in FIG. 4 has features in that the step difference 26 is uniformly formed at the central part of the ceramic substrate 3 in the inner half region on the lead side of the square package, and the monitor photodiode 13 is arranged at one part of the step difference 26. Thus, the monitor photodiode 13 can be easily wired by effectively using the step difference 26, and a state that is spacious overall is achieved.

The semiconductor laser light B output from the optical element 8 is output outwardly through the optical system unit (lens) 9. Other configurations are the same as the first exemplary embodiment described above.

### Third Exemplary Embodiment

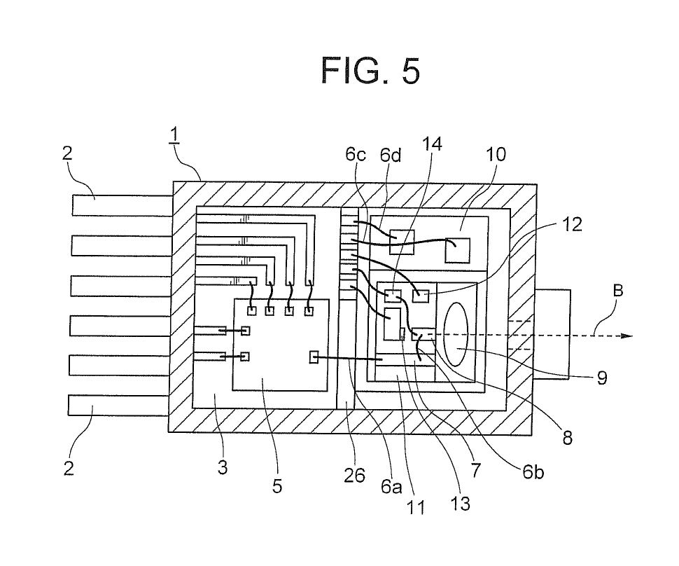

A third exemplary embodiment will now be described based on FIG. 5.

Same reference numerals are used for the components same as in the first exemplary embodiment described above. The third exemplary embodiment shown in FIG. 5 has features in that the step difference 26 is uniformly formed at the central part of the ceramic substrate in the inner half region on the lead side of the square package. At the same time, the monitor photodiode 13 is mounted on the upper surface of the carrier 11 in FIG. 5.

The semiconductor laser light B output from the optical element 8 is output outwardly through the optical system unit 9. Other configurations are the same as the first exemplary embodiment described above.

The third exemplary embodiment uses the laser element alone for the optical element 8. In FIG. 5, the impedance of the transmission path is small. Thus, the terminating resistor 18 is unnecessary. Furthermore, an advantage in that power is supplied to the optical element 8 only in one system is obtained. Other configurations are the same as the first exemplary embodiment described above.

### Fourth Exemplary Embodiment

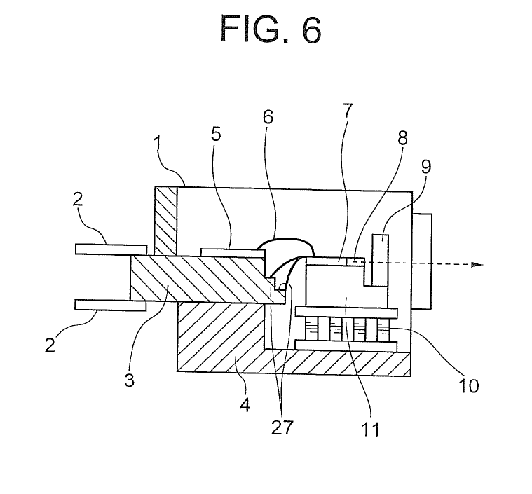

A fourth exemplary embodiment will now be described based on FIG. 6. Same reference numerals are used for the components same as in the first exemplary embodiment described above.

The fourth exemplary embodiment shown in FIG. 6 has features in that a plurality of step differences is uniformly formed at the central part of the ceramic substrate in the inner half region on the lead side of the square package. At the same time, the monitor photodiode 13 is mounted on the upper surface of the carrier 11 in FIG. 6.

A plurality of leads 2 is arranged in a projecting manner in two stages of upper and lower stages, and the ceramic substrate 3 is interposed in between. The base member 4 and the ceramic substrate 3 are stacked from the lower side towards the upper side in the inner half region on the lead 2 side of the package 1 at one end of the square package 1, and the driver IC is mounted on the ceramic substrate 3.

Furthermore, in another inner half region opposite to the lead 2 of the package 1, the thickness of the base member 4 is thinned and the Peltier elements 10 and the carrier 11 are stacked from the lower side towards the upper side, and furthermore, the optical element 8 and the optical system unit (lens) 9 are sequentially stacked in a direction opposite to the leads on the upper surface of the carrier 11, so that the semiconductor laser light B output from the optical element 8 is output outwardly through the optical system unit 9.

A step difference 27 of at least two stages is formed at the step part of the central part of the ceramic substrate in the inner half region on the lead side of the package, and wirings for the driver IC and the semiconductor laser power supply terminals are arranged on the step difference 27 of each two (or more) stages.

Furthermore, the monitor photodiode 13 is mounted on the upper surface of the carrier and on the back side of the optical element 8. The monitor photodiode 13 is easily wired by effectively using the step difference. Other configurations are the same as the first exemplary embodiment described above.

In the first to fourth exemplary embodiments described above, the optical transmission module for transmitting the optical signal output by the optical element 8 has been described for the optical communication module, but is not limited thereto. These exemplary embodiments may be applied to an optical reception module for receiving and processing the externally input optical signal, similarly. When the exemplary embodiment of the present invention is applied to the optical reception module, the optical element 8 corresponds to an element for executing the function of receiving and processing the optical signal input through the optical system unit 9. In this case, the step difference 26 used as a space for wiring process, element mounting, and the like is formed at the edge of the ceramic substrate 3 placed adjacent to the optical element for optical signal processing.

Therefore, in the optical transmission module and the optical reception module, which are optical communication modules, the height dimension of the optical communication module can be reduced in the height direction of the optical element by adjusting the height position of the step difference in correspondence to the optical element of the optical element transmission/reception module.

### Fifth Exemplary Embodiment

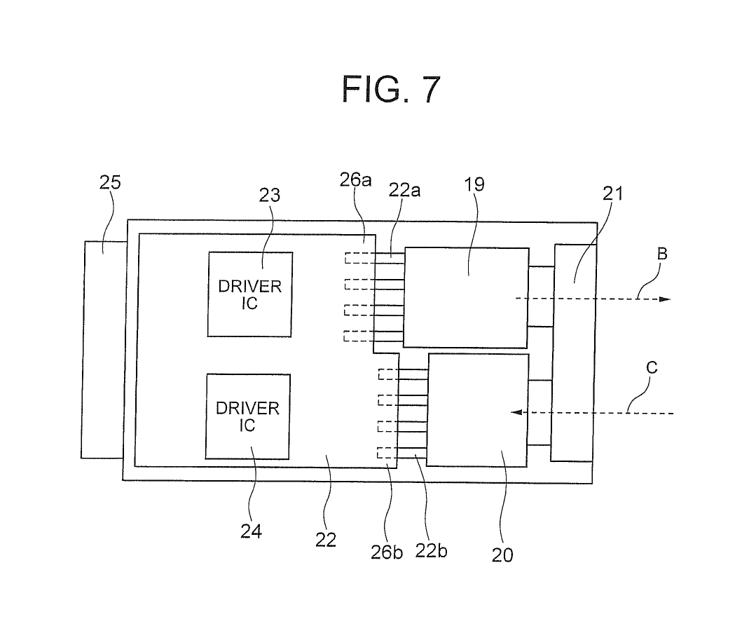

A fifth exemplary embodiment will now be described based on FIG. 7.

As shown in FIG. 7, a wiring substrate 22, an optical transmission module 19, and an optical reception module 20 are mounted on a housing 21 of the optical transceiver. A transmission driver IC 23 and a reception driver IC 24 are mounted on the wiring substrate 22, and the wiring substrate 22 is electrically connected to an electrical connector 25.

In other words, the optical transmission module 19 and the optical reception module 20 are removably engaged to the wiring substrate 22, and the transmission driver IC 23 and the reception driver IC 24 are electrically connected to the wiring substrate 22. The optical transmission module 19 is input with the optical signal output from the transmission driver IC 23 and outputs the optical signal B to the outside. The optical reception module 20 receives the optical signal C input from the outside, and outputs the received signal to the reception driver IC 24.

Step differences 26a, 26b are each formed at the edge of the wiring substrate 22 placed adjacent to the optical transmission module 19 and the optical reception module 20, and the wiring process of the optical transmission module 19 and the optical reception module 20 with respect to the wiring substrate 22 is performed using the step differences 26a, 26b. That is, the step differences 26a, 26b are respectively formed at the height position where the lead 22a of the optical transmission module 19 and the lead 22b of the optical reception module 20 can be received. The leads 22a, 22b are received at the step differences 26a, 26b, and the wiring substrate 22 and the optical transmission/reception modules 19, 20 are wiring processed on the step differences 26a, 26b. The step differences 26a, 26b may be formed at different heights in correspondence to the heights of the optical transmission/reception modules 19, 20. The inner configuration of the optical transmission module 19 and the optical reception module 20 may be similar to the first to fourth exemplary embodiments described above.

As described above, in the optical transceiver in which the optical transmission/reception modules 19, 20 are mounted in the package 21, the step differences 26a, 26b are formed at the edge of the wiring substrate 22 adjacent to the optical transmission/reception modules 19, 20, and wiring process etc. is performed using the step differences 26a, 26b. In particular, the terminals of the optical transmission/reception modules 19, 20 can be collected in correspondence to the step differences 26a, 26b by forming the step differences 26a, 26b so as to face one direction of the optical transmission/reception modules 19, 20, whereby the lateral width of the optical transceiver can be reduced and a small transceiver can be realized. Furthermore, the height dimension of the optical transceiver can be reduced in the height direction of the modules 19, 20 by adjusting the height position of the step differences in correspondence to the optical transmission/reception modules 19, 20.

Further, as a sixth exemplary embodiment of the invention, a configuration of interposing the ceramic substrate between the plurality of leads on one side and the other side arranged in a projecting manner over two stages of upper and lower stages may be adopted.

Furthermore, in order to achieve the object of the invention, an optical communication transmission module of the seventh exemplary embodiment of the invention may be an optical communication transmission module in which a plurality of lead terminals is arranged in a projecting manner over two stages of upper and lower stages at one end of a package; a base member and a ceramic substrate are stacked from the lower side towards the upper side in an inner half region of the package; a driver IC is mounted on the ceramic substrate; the thickness of the base member is thinned and the Peltier elements and the carrier are stacked from the lower side towards the upper side, and the optical element and the optical system unit are sequentially arranged in a direction opposite to the leads on the carrier at another end on the inner side of the package; and the semiconductor laser light output from the optical element is output outwardly through the optical system unit; wherein a step difference of at least two stages is formed at the step part of the central part of the ceramic substrate in the inner half region on the lead side of the package, and wirings for the driver IC and the semiconductor laser power supply terminals are arranged on each step difference.

Moreover, as an eighth exemplary embodiment of the invention, a configuration of arranging the monitor photodiode on the upper surface of the carrier and on the back side of the optical element may be adopted.

Further, as a ninth exemplary embodiment of the invention, a configuration of arranging the monitor photodiode at the step difference may also be adopted.

Furthermore, in the optical communication transmission module according to the tenth exemplary embodiment, an optical transceiver may be provided including an electrical connector with a plurality of terminals and arranged with a wiring substrate connected to the electrical connector at one end, and including an optical transmission module and an optical reception module for optical communication arranged at the other end, the optical transmission module and the optical reception module being removably engaged to the wiring substrate by way of a plurality of leads, and a transmission driver IC and a reception driver IC being mounted on the wiring substrate; where the semiconductor laser light is output outwardly or externally input with respect to the housing on the side opposite to the wiring substrate of the optical transmission module and the optical reception module; a step difference is formed at the step part of the central part of the ceramic substrate in an inner half region on the lead side in the optical transmission module and the optical reception module; and the wiring for the driver IC and the semiconductor laser power supply terminals are arranged on the step difference.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

A practicable example of the element of the optical communication transmission module includes being used as an optical module that can be mounted on the optical transmission device, router, and the like, and that can be mounted on a small transceiver.

What is claimed is:

1. An optical communication module comprising an optical element for performing transmission and reception of optical signals and a substrate mounted with a driver for drive controlling the transmission and reception of the optical element in a package; wherein
a step difference is formed at an edge of the substrate facing the optical element.

2. The optical communication module according to claim 1, wherein wiring process of the optical element and the substrate is performed on the step difference.

3. The optical communication module according to claim 1, wherein a part of an element configuring the optical element is mounted on the step difference.

4. The optical communication module according to claim 1, wherein terminals of the optical element are collected at a position facing the step difference.

5. The optical communication module according to claim 1, wherein the step difference is formed in plurals at different heights.

6. The optical communication module according to claim 5, wherein mutual interference of a plurality of lines formed on the substrate is eliminated by using the step differences of different heights.

7. An optical transceiver comprising an optical communication module and a substrate mounted with a driver for drive controlling the optical communication module in a package, wherein
a step difference is formed at an edge of the substrate facing the optical communication module.

8. The optical transceiver according to claim 7, wherein wiring process of the optical element and the substrate is performed on the step difference.

9. The optical transceiver according to claim 7, wherein terminals of the optical element are collected at a position facing the step difference.

10. The optical transceiver according to claim 7, wherein the step difference is formed in plurals at different heights.
